(19) United States
(12) Patent Application Publication
(10) Pub. No.: US 2001/0041127 A1
(43) Pub. Date: Nov. 15, 2001

(54) Side loading waste bin

(76) Inventor: John B. Cross, New South Wales (AU)

Correspondence Address: OSTROLENK FABER GERB & SOFFEN, 1180 AVENUE OF THE AMERICAS, NEW YORK, NY, 100368403

(21) Appl. No.: 09/853,910

(22) Filed: May 11, 2001

(30) Foreign Application Priority Data
May 12, 2000 (AU) PQ7478

(51) Int. Cl. B65F 3/26; B60P 1/04

(52) U.S. Cl. 414/470

(57) ABSTRACT

A method and apparatus for recycling bulk waste materials from commercial industrial or building sites, uses a truck (2) having a support platform (1) and a lifting mechanism with pivoting arms (4A) and (4B) located toward the front and rear of the platform (1) joined at their distal ends by a beam (5). Various sizes and combinations of bulk waste collection bins (6) can be loaded and unloaded from the side of the truck (2) by suspending selected bins from the beam (5) by chains (17).

The method enables flexibility and efficiency of truck operation by allowing the operator to select desired combinations of bulk waste disposal bins containing sorted recyclable waste for loading, unloading and delivery to disposal points which can include intermediate disposal points in the form of further bulk waste receiving bins. The configuration of the apparatus allows the lifting mechanism to tip loaded bulk waste bins into similar receiving bins on the ground, which in turn can be loaded onto the truck for disposal.

### FIELD OF THE INVENTION

The present invention relates to a method and apparatus for handling bulk waste bins. It has been developed primarily for use in the recycling of bulk waste material and other waste removal applications and will be described with reference to these applications. It will be appreciated, however, that the invention is not limited to that particular field of use.

### BACKGROUND OF THUS INVENTION

In the past mixtures of bulk waste such as that generated by factories or building sites have been collected in large bins or skips without any consideration to classification or separation of the waste to facilitate efficient recycling. As a result, large volumes of potentially recyclable materials such as glass, lumber, concrete and the like have been disposed of in rubbish tips.

Such tips are limited in size and are rapidly filled by large volumes of such waste. Accordingly, because of their limited size, fees are levied for the use of such tips. These fees can be a large expense for many builders and other waste producers. Furthermore, the disposal of potentially recyclable material places added demands on an already stressed environment.

Limited attempts have been made to date to recycle various types of waste from building sites or factories such as the disposal of concrete rubble for use in road base, but there is no known system of collecting sorted waste building materials and industrial waste, and in efficiently gathering and transporting those materials to their intended disposal points.

Accordingly, it is an object of the present invention to overcome or ameliorate at least one of the disadvantages of the prior art, or to provide a useful alternative.

### DISCLOSURE OF THE INVENTION

In one aspect, the present invention provides a method of recycling bulk waste materials, including the steps of:

providing a vehicle adapted to lift bulk waste collection bins from positions alongside the vehicle onto a support platform on the vehicle;

providing a plurality of said bulk waste collection bins to one or more collection sites, said bins being classified for the collection of selected classes of recyclable material;

collecting selected bins which have been at least partially filled with sorted recyclable material from the collection sites by lifting those bins onto the support platform on the vehicle;

delivering the bins so collected to a disposal point for a selected class of recyclable material; and

emptying those bins containing material appropriate for that disposal point by tipping over the side of the vehicle.

Preferably the vehicle is adapted to carry a plurality of said bulk waste collection bins in a longitudinal row on said support platform, and at least two said bins are collected and transported to different disposal points for different classes of recyclable material.

Preferably said vehicle is adapted to tip said bulk waste collection bins over the side of the vehicle in such a way that the contents can be tipped into a receiving bin on the ground alongside the vehicle, and the method includes the step of using the receiving bin as an intermediate disposal point by tipping the contents of one or more selected bulk waste collection bins into the receiving bin.

Preferably said vehicle is adapted to lift the receiving bin from a position alongside the vehicle onto the support platform, and the method includes the step of so lifting the receiving bin onto the support platform, delivering the receiving bin to a disposal point, and emptying the receiving bin by tipping over the side of the vehicle.

In a further aspect, the invention provides apparatus for handling bulk waste collection bins, said apparatus including a vehicle provided with a support platform and a lifting mechanism adapted to transfer the bulk waste collection bins firm a position on the ground alongside the vehicle to the support platform, said lifting mechanism including a pair of pivoting support arms, one located towards the front of the support platform and the other towards the rear of the support platform, and a longitudinal beam extending between the support arms, arranged such that the bins may be suspended from the beam and lifted onto the platform by pivoting the support arms relative to the support platform.

Preferably each support arm is articulated, the articulation movement and the pivoting movement relative to the platform being actuated by hydraulic piston and cylinder assemblies.

Preferably the support platform and the beam are sufficiently long to enable a plurality of bulk waste collection bins to be lifted and placed in a longitudinal row on the support platform.

Preferably the bulk waste collection bins are suspended from the beams by tendons such as chains, which can be coupled or uncoupled between selected bins and the beam, enabling an operator to select various combinations of bins for loading or unloading upon actuation of the pivoting support arms.

Preferably bins on the support platform suspended from the beam may be lifted by actuation of the pivoting support arms and tipped to the side of the vehicle by providing one or more tipping tendons connected between a location on those bins to be tipped towards the tipping lip of the bin, and an anchor point on the vehicle, arranged such that further pivoting of the support arms causes the tipping tendons to become tight, pulling the tipping lip of the bin downwardly as the bin is lifted and moved to the side of the vehicle.

Preferably the tipping tendons are arranged to be connected between a location adjacent the tipping lip of the bin, and a position towards the opposite edge of the support platform.

Preferably the pivoting support arms, beam, and tipping tendons are arranged such that a bin being tipped from the vehicle is lifted to a position enabling the contents of that bin to be tipped into a similar bin positioned on the ground alongside the vehicle.

### BRIEF DESCRIPTION OF THE DRAWINGS

Notwithstanding any other forms that may fall within its scope, one preferred form of the invention will now be described by way of example only with reference to the accompanying drawings in which:

FIG. 1 is a rear end view of a vehicle incorporating apparatus for handing bulk waste collection bins according to the invention with the lifting mechanism in a retracted position.

FIG. 2 is a similar view to FIG. 1 showing vehicle support jacks lowered and the lifing mechanism in a partially deployed position;

FIG. 3 is a similar view to FIG. 2 with the lifting mechanism extended and a bin located just above ground level;

FIG. 4 is a similar view to FIG. 3 showing the tipping mechanism actuated and a bulk waste collection bin being tipped into a receiving bin on the ground alongside the vehicle;

FIG. 5 is a side view of the vehicle shown in FIG. 1 with a plurality of nested bins of different sizes in place on the support platform;

FIG. 6 is a similar view to FIG. 5 showing a different mix of full and empty bulk waste collection bins; and

FIG. 7 is a similar view to FIG. 6 showing an intermediate size of bulk waste collection bins in place on the support platform.

### PREFERRED EMBODIMENT OF THE INVENTION

In the preferred form of the invention, an apparatus for recycling bulk waste materials is constructed as follows, although it will bet appreciated that the apparatus can be mounted on different types of vehicles and be of different sizes or configurations without departing from the scope of the invention.

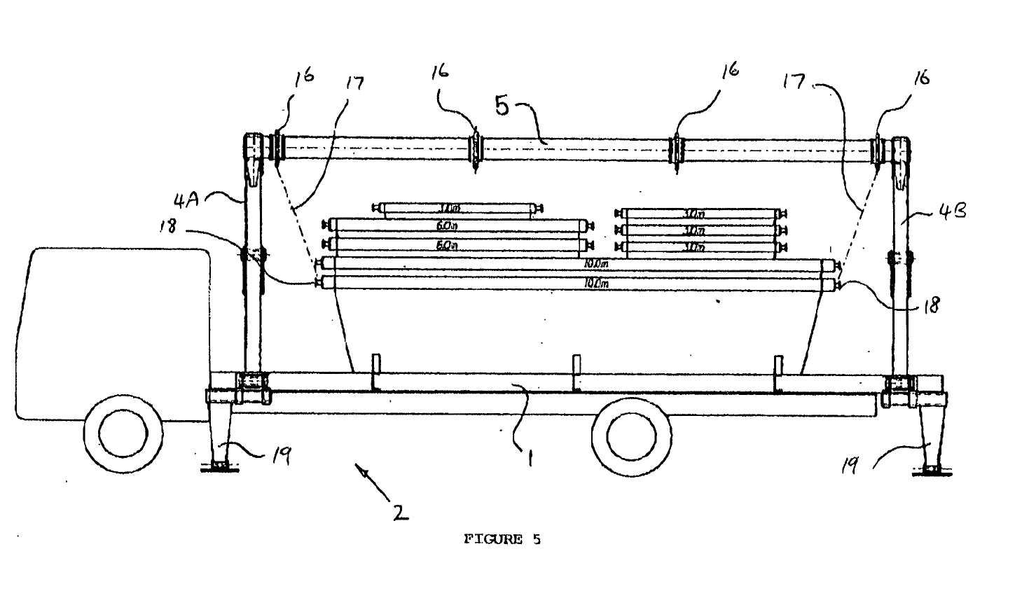

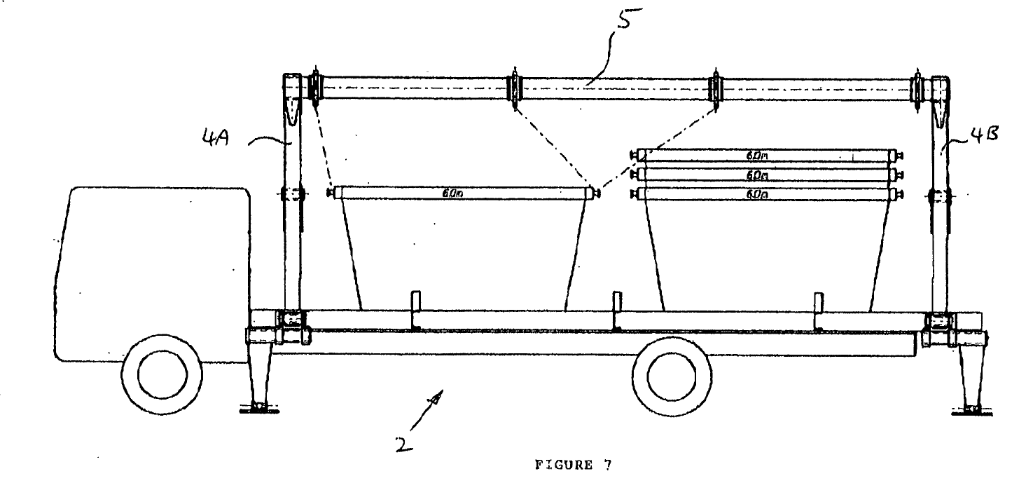

The apparatus includes a support platform 1 mounted on or forming part of the chassis of a vehicle 2 typically in the overall configuration of a flat bed truck as can be seen diagrammatically in FIGS. 5 to 7.

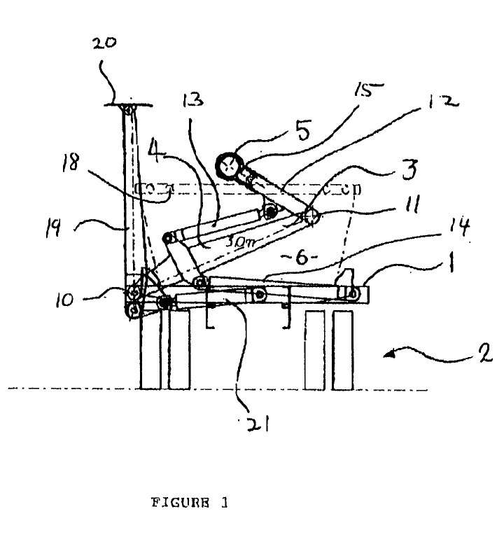

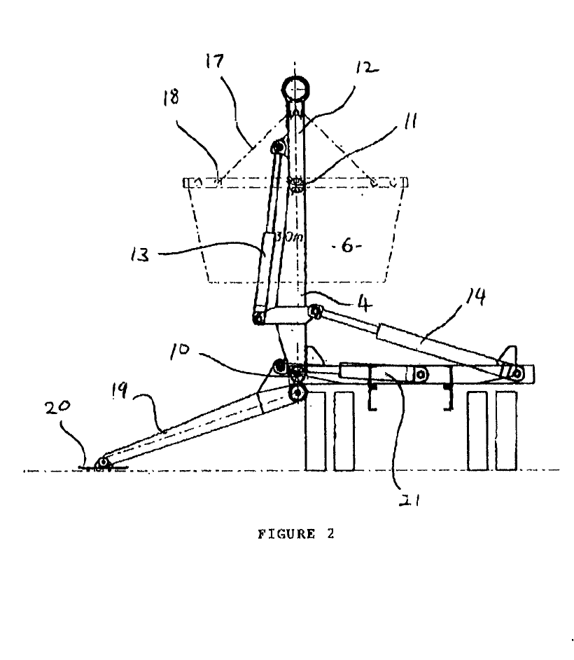

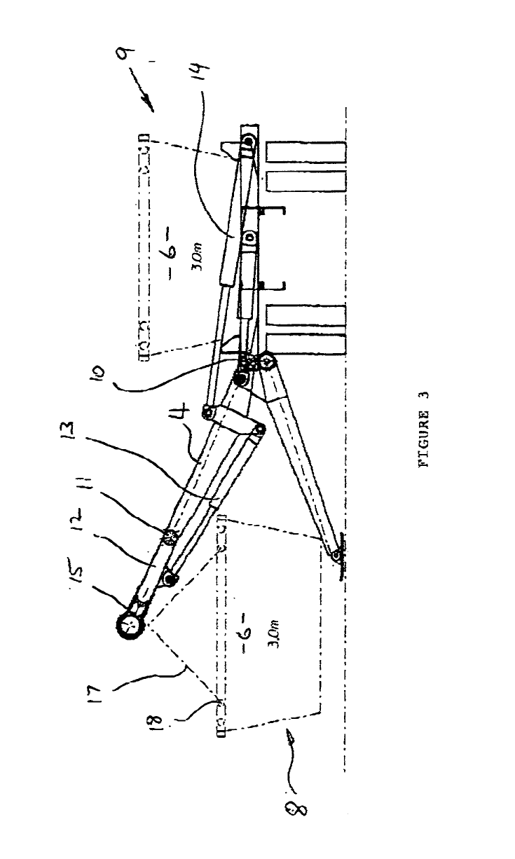

The apparatus includes a lifting mechanism 3 adapted to transfer bulk waste collection bins 6 (shown in broken outline in FIGS. 1 to 4) from a position on the ground alongside the vehicle, as shown at 8 in FIG. 3, to the support platform as shown at 9. The lifting mechanism includes a pair of pivoting support arms 4 pivotally mounted to the support platform or the chassis of the vehicle at 10 for movement between a retracted position as shown in FIG. 1, through a partially deployed position as shown in FIG. 2 to a delivery position as shown in FIG. 3. The support arm is articulated at an “elbow” pivot 11 with a distal portion 12 moveable between a folded position as shown in FIG. 1 to an extended position as shown in FIGS. 2 and 3 by a hydraulic piston and cylinder assembly 13.

The pivoting support arm 4 is in turn pivoted around pivot pin 10 by a hydraulic piston and cylinder assembly 14.

Two such arms are provided, there being a forward pivoting support arm 4A (FIG. 5) located towards the front of the support platform 1, and a rearward pivoting support arm 4B located towards the rear of the support platform 1.

Extending between the distal ends 15 of the forward and rearward support arms 4A and 4B is a beam 5 which may be of any suitable cross section but which is typically tubular in configuration. The beam is provided with anchor points 16 at convenient locations adapted to receive and support tendons such as chains, wire cables, or the like which can be coupled or uncoupled between selected bins and the beam to suspend selected bins from the beam for lifting on or off the vehicle.

The lifting chains are shown in long chain outline at 17 and are engaged with lugs 18 protruding from the upper lip of the waste bins 6.

To lift a bulk waste collection bin from the support platform on the vehicle in the position shown in FIG. 1, a set of chains 17 is engaged between appropriate points 16 on the support beam and lugs 18 on the bin. The vehicle and support platform 1 are typically stabilised and prevented from tipping over by the use of pivoting support jacks 19 which are pivoted downwardly and outwardly from the vehicle to the position shown in FIG. 2 with a support foot 20 at the distal end of the jack on the ground surface, by the actuation of further hydraulic piston and cylinder assemblies 21.

The pivoting support arms 4 are then pivoted about their pivotal mountings 10 by actuation of hydraulic piston and cylinders 14, and the arms straightened from the bent position shown in FIG. 1 to the straight position shown in FIGS. 2 and 3 by the actuation of cylinders 13. The bin 6 is lifted by the chains 17 from the support platform as shown in FIG. 2 and carried out over the side of the vehicle to be deposited on the ground alongside the vehicle as seen in FIG. 3.

Empty bins placed on the ground in this manner may then be filled with selected materials, preferably materials for recycling, and at a later visit of the vehicle, lifted back onto the support platform by a reverse of the procedure described above.

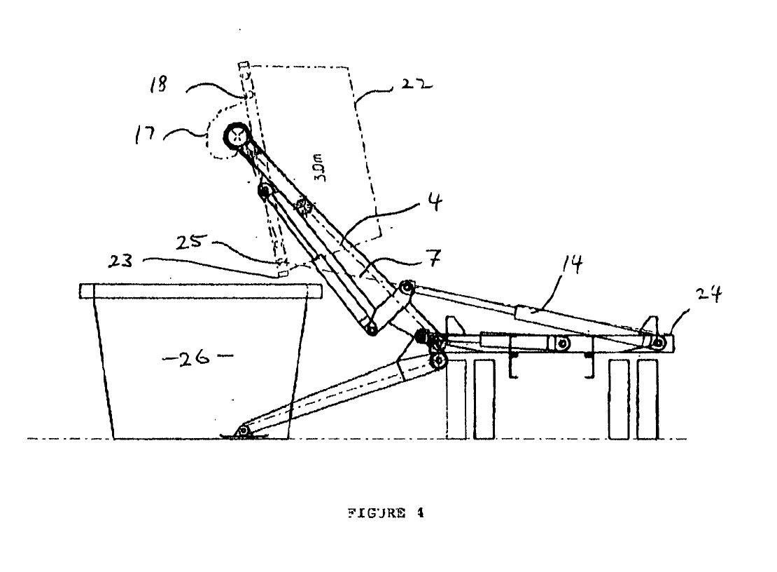

When it is desired to tip the contents of a bin from the vehicle, tipping tendons in the form of chains shown in long chain outline at 7 (FIG. 4) are provided, and interconnected between a location on the bin being tipped 22 which is positioned towards the tipping lip 23 of the bin, and an anchor point 24 on the vehicle, arranged such that pivoting of the support arms as shown in FIG. 4 causes the tipping chain 7 to become tight pulling the tipping lip 23 of the bin downwardly as the bin is lifted and moved to the side of the vehicle. In the preferred form of the invention, the tipping chain is connected between a lug 25 on the side of the bin adjacent the tipping lip 23, and the position 24 which is located on or towards the opposite edge of the support platform as can be clearly seen in FIG. 4.

It is a particular feature of the invention, that the configuration of the pivoting arms 4 and the tipping mechanism described in connection with FIG. 4 enable a bin to be tipped to be first lifted to an elevated position so that the contents of the bin 22 may be tipped into a similar receiving bin 26 located on the ground alongside the vehicle.

The receiving bin 26 is typically larger than the bulk waste collection bins 6, but of a similar configuration enabling it to be in turn lifted onto the support platform 1 of the vehicle by the mechanism and process described above.

At the point of final disposal, either directly from the bulk waste collection bins 6, or from one or more receiving bins 26 transported to the ultimate disposal site on the vehicle 2, the relevant bin or bins may be selected by engaging the chains from that bin to the beam 5, and the bin tipped through the position shown in FIG. 4 to a disposal chute (not shown) or to a disposal position on the ground for collection of the sorted material from that bin.

The apparatus described above allows bins 6 to be transferred over the side of the platform rather than over the rear of the truck as has been the common practice with waste bins of this type to date. In this way, it is no longer necessary for the vehicle to be reversed up to a filled bin. Indeed, the vehicle can pill up at the side of a road and deliver the bin over the side and onto the curb. Similarly, once the bin has been filled the vehicle only needs to be maneuvered alongside to pick up the bin.

Even greater benefits are provided when a number of smaller bins or mixes of small and large bins are used as shown in FIG. 5. In this way, different types or grades of waste, glass, concrete, steel, clean fill etc. can be separated into different bins. A number of these smaller bins can separately or simultaneously be transferred from the ground onto the platform in a longitudinal row. Similarly, they can be separately or simultaneously unloaded or emptied at appropriate disposal or recycling facilities.

Because of the tipping mechanism described above with reference to FIG. 4, the apparatus is capable of tipping the contents of a smaller bin into another (typically larger) bin which is on the ground. This enables a vehicle to visit a number of waste producing sites and collect a number of smallest bins of recyclable material to be emptied into a large container load of a given grade of material before making a trip to the appropriate disposal or recycling facility.

Also, as illustrated in FIGS. 5, 6 and 7, the apparatus is capable of carrying stacks of empty nested bins. These stacks are built on the ground adjacent the vehicle and transferred onto the support platform. Also, it will be appreciated that loaded bins may also be carried on top of a stack of empty nested bins.

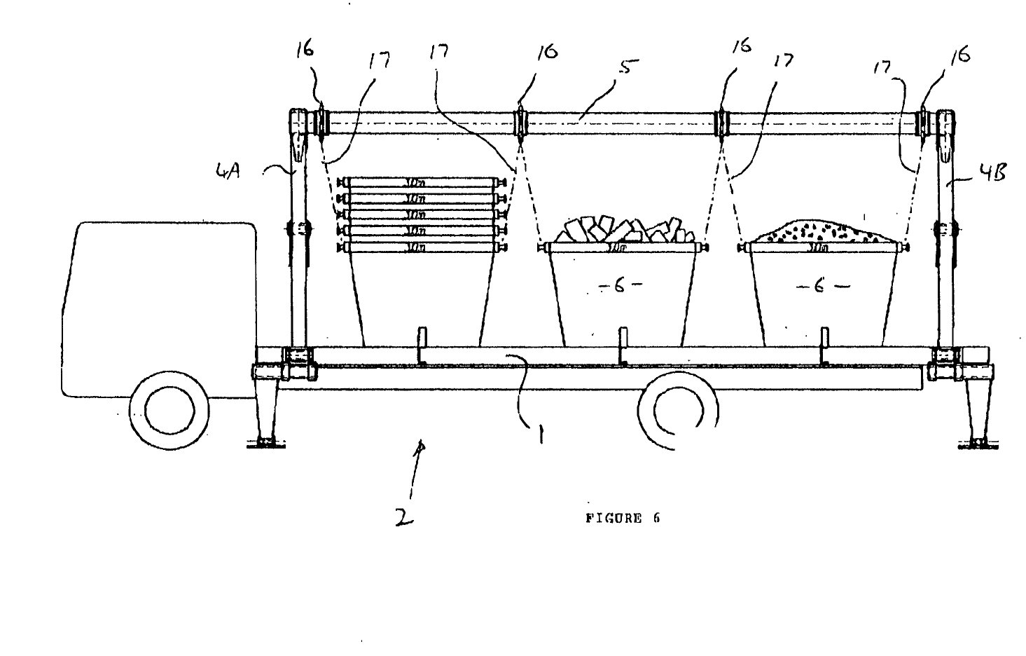

Another particularly useful feature is the use of a number of different bin sizes. As shown to advantage in FIGS. 5 and 6, the bins are sized so that they can be nested within bins of equivalent or larger sizes. In this way, the various bins required by any waste-producing site can be carried in a single load. Alternatively, the vehicle can be loaded with sufficient bins for delivery to a number of sites without having to return to base before each delivery. This capability even provides benefits for the manufacturer of the bins and waste removal operators due to the reduced yard space requirements.

The features described above have particular advantages for use in recycling of building, demolition or other types of waste where the waste material includes one or more grades of waste that can be recycled together with some nonrecyclable components.

In the past, large bins or skips have been delivered to building sites or the like and are then loaded with a mixture of materials. As the materials are mixed and not sorted into respective grades, they cannot be recycled. Instead, they are disposed of in landfill sites at a high cost. This is not only expensive for the builder but is an unnecessary waste of raw materials and an unwelcome burden on councils who are hard pressed to come up with landfill facilities.

As an alternative, after consulting with the building site operator to determine the different grades of waste material produced and the volumes produced, a recycling service operator will provide sufficient bins to take care of the waste. Generally, due to the nestibility of the various sized bins, this can be done in a single delivery.

Each of the bins can be provided with a detachable lid which is lockable and spring assisted to open. In this way, the site manager can control access to each of the bins by issuing only appropriate keys to appropriate workers or subcontractors. As a result, workers primarily producing a certain kind of waste will only be able to dispose of it in the appropriate bin to which they have been given access.

Once filled, the service operator will be called to empty the containers. As a result of the side loading trucks used, it is a simple exercise to pick up one or more of the bins which will have been left on site or at the roadside. If a similar scheme was attempted with standard (rear loading) bin transport trucks, the difficulties in locating a range of bins for regular access would be substantial as the trucks must have sufficient road space to reverse up to the bin.

For larger bins, possibly used for concrete waste or clean fill, once filled they will be taken directly to an appropriate recycling centre. For example, concrete waste is often accepted free of charge for use as road base. Clean fill is also commonly accepted free of charge at landfill stations and is used to cover other “putrescible” waste.

For smaller bins, possibly used for paper, glass, steel or the like, they are loaded onto the support platform of a truck for transport to one of a number of transfer or intermediate points located within the service operators area of operation. At this point, larger bins may be provided for each grade of waste. The smaller bins collected from various sites are tipped into the larger bins and then stacked ready for redistribution. Once full, the larger bins are taken to appropriate recycling centres. Many grades of waste such as paper, glass, steel and plastics attract payments which in many cases can offset the remaining landfill costs for nonrecyclable grades of waste. Also, there is less waste of valuable commodities such as glass, lumber, steel etc.

Additionally, there are benefits for the service operator. Existing bin delivery trucks are restricted to operating during landfill station operating hours. Possibly, this may be extended slightly by picking up a full bin before the station opens and delivering an empty bin after the station closes. This limitation results from the inability of existing trucks to carry more than one bin at any one time, whether it is fail or empty. For each trip made with a full bin to a landfill station or recycling plant, they must make a return journey with an empty bin.

By using the apparatus for handling bulk waste as described above the trucks can keep operating after the landfill station or recycling center closes. Full waste collection bins can continue to be transported to an intermediate disposal point. The waste collection bins can then be emptied into larger receiving bins ready for further distribution. When the station opens, the filled receiving bins can be quickly emptied and stacked ready for further deployment. As a result, every time that a truck comes in to empty a load it can return to the field with a stack of bins to be distributed to various sites. It will be appreciated that this removes the need for wasted trips and can increase the efficiency of a recycling operation. Similar benefits would also result for other waste removal applications.

Furthermore, a large proportion of the trips between sites and the landfill station and recycling center are done at night and the reduced traffic at these times can result in shorter trip times.

Although the invention has been described with reference to specific examples it will be appreciated by those skilled in the art that the invention may be embodied in many other forms.

I claim:

1. A method of recycling bulk waste materials, including the steps of:
providing a vehicle adapted to lift bulk waste collection bins from positions alongside the vehicle onto a support platform on the vehicle;
providing a plurality of said bulk waste collection bins to one or more collection sites, said bins being classified for the collection of selected classes of recyclable material;
collecting selected bins which have been at least partially filled with sorted recyclable material from the collection sites by lifting those bins onto the support platform on the vehicle;
delivering the bins so collected to a disposal point for a selected class of recyclable material; and
emptying those bins containing material appropriate for that disposal point by tipping over the side of the vehicle.

2. A method as claimed in claim 1 wherein the vehicle is adapted to carry a plurality of said bulk waste collection bins in a longitudinal row on said support platform, and wherein at least two said bins are collected and transported to different disposal points for different classes of recyclable material.

3. A method as claimed in claim 1 wherein said vehicle is adapted to tip said bulk waste collection bins over the side of the vehicle in such a way that the contents can be tipped into a receiving bin on the ground alongside the vehicle, and wherein the method includes the step of using the receiving bin as an intermediate disposal point by tipping the contents of one or more selected bulk waste collection bins into the receiving bin.

4. A method as claimed in claim 3 wherein said vehicle is adapted to lift the receiving bin from a position alongside the vehicle onto the support platform, and wherein the method includes the step of so lifting the receiving bin onto the support platform, delivering the receiving bin to a disposal point, and emptying the receiving bin by tipping over the side of the vehicle.

5. Apparatus for handling bulk waste collection bins, said apparatus including a vehicle provided with a support platform and a lifting mechanism adapted to transfer the bulk waste collection bins from a position on the ground alongside the vehicle to the support platform said lifting mechanism including a pair of pivoting support arms, one located towards the front of the support platform and the other towards the rear of the support platform, and a longitudinal beam extending between the support arms, arranged such that the bins may be suspended from the beam and lifted onto the platform by pivoting the support arms relative to the support platform.

6. Apparatus as claimed in claim 5 wherein each support arm is articulated, the articulation movement and the pivoting movement relative to the platform being actuated by hydraulic piston and cylinder assemblies.

7. Apparatus as claimed in claim 5 wherein the support platform and the beam are sufficiently long to enable a plurality of bulk waste collection bins to be lifted and placed in a longitudinal row on the support platform.

8. Apparatus as claimed in claim 7 wherein the bulk waste collection bins are suspended from the beam by tendons such as chains, which can be coupled or uncoupled between selected bins and the beam, enabling an operator to select various combinations of bins for loading or unloading upon actuation of the pivoting support arms.

9. Apparatus as claimed in claim 5 wherein bins on the support platform suspended from the beam may be lifted by actuation of the pivoting support arms and tipped to the side of the vehicle by providing one or more tipping tendons connected between a location on those bins to be tipped towards the tipping lip of the bin, and an anchor point on the vehicle, arranged such that further pivoting of the support arms causes the tipping tendons to become tight, pulling the tipping lip of the bin downwardly as the bin is lifted and moved to the side of the vehicle.

10. Apparatus as claimed in claim 9 wherein the tipping tendons are arranged to be connected between a location adjacent the tipping lip of the bin, and a position towards the opposite edge of the support platform.

11. Apparatus as claimed in claim 9 wherein the pivoting support arms, beam, and tipping tendons are arranged such that a bin being tipped from the vehicle is lifted to a position enabling the contents of that bin to be tipped into a similar bin positioned on the ground alongside the vehicle.
